(19) United States
(12) Patent Application Publication
(10) Pub. No.: US 2005/0284007 A1
(43) Pub. Date: Dec. 29, 2005

(54) Advertising display apparatus

(76) Inventor: Ahmed Ismael, Mississauga (CA)

Correspondence Address: YOUNG & BASILE, P.C., 3001 WEST BIG BEAVER ROAD, SUITE 624, TROY, MI, 48084, US

(21) Appl. No.: 11/122,673

(22) Filed: May 5, 2005

Related U.S. Application Data
(60) Provisional application No. 60/568,462, filed on May 5, 2004.

(51) Int. Cl. G09F 1/00

(52) U.S. Cl. 40/124.03

(57) ABSTRACT

An advertising display apparatus is disclosed. The apparatus comprises a printed material display portion and a presentation portion. The display portion includes a plurality of printed material holders for holding printed materials. The presentation portion includes video means for displaying visual images. In use, the visual images can be viewed by passers-by and the printed material holders are positioned such that passers-by can conveniently peruse the information on the printed materials held by the holders and draw printed materials therefrom as desired.

### PRIOR APPLICATION

This application is based in part on and claims priority on the basis of earlier filed U.S. Provisional Patent Application Ser. No. 60/568,462 filed May 5, 2004.

### FIELD OF THE INVENTION

The present invention relates to the field of advertising, and more particularly, to advertising display apparatus.

### BACKGROUND OF THE INVENTION

Business card and brochure display apparatus are well-known in the prior art. For example, U.S. Pat. No. 5,046,273 (Virvo), issued Sep. 10, 1991, teaches a PORTABLE DISPLAY SYSTEM which includes a brochure pocket, a business card pocket and an illuminated panel, for displaying transparencies. This apparatus is known to be capable of serving as a repository for brochures and business cards, but is not known to have received widespread consumer acceptance.

### SUMMARY OF THE INVENTION

An advertising display apparatus forms one aspect of the invention. The apparatus comprises a printed material display portion and a visual display portion. The printed material display portion includes a plurality of printed material holders. The visual display portion includes video means for displaying visual images. The apparatus has an operative configuration wherein the visual display portion is positioned such that the visual images can be viewed by passers-by, and wherein the printed material holders are positioned such that passers-by can conveniently peruse the information on the printed material and draw printed materials from the pockets as desired.

Advantages, features and characteristics of the present invention, as well as methods of operation and functions of the related elements of the structure, and the combination of parts and economies of manufacture, will become more apparent upon consideration of the following detailed description with reference to the accompanying drawings, the latter being briefly described hereinafter.

### BRIEF DESCRIPTION OF THE DRAWINGS

FIG. 1 is a perspective view of an advertising display apparatus constructed according to a first preferred embodiment of the invention;

FIG. 2 is a front elevational view of the structure identified with reference numeral 30 in FIG. 1, in a first appearance;

FIG. 3 is a view of the structure of FIG. 2, in a second appearance;

FIG. 4 is view similar to FIG. 1, with upper and lower panels shown ajar;

FIG. 5 is a perspective view of an advertising display apparatus constructed according to a second preferred embodiment of the invention;

FIG. 6 is a perspective view of an advertising display apparatus according to a third preferred embodiment of the invention;

FIG. 7 is a front elevational view of the structure identified with reference numeral 30′ in FIG. 6, in a first appearance; and

FIG. 8 is a view of the structure of FIG. 7, in a second appearance.

### DETAILED DESCRIPTION OF PREFERRED EMBODIMENTS

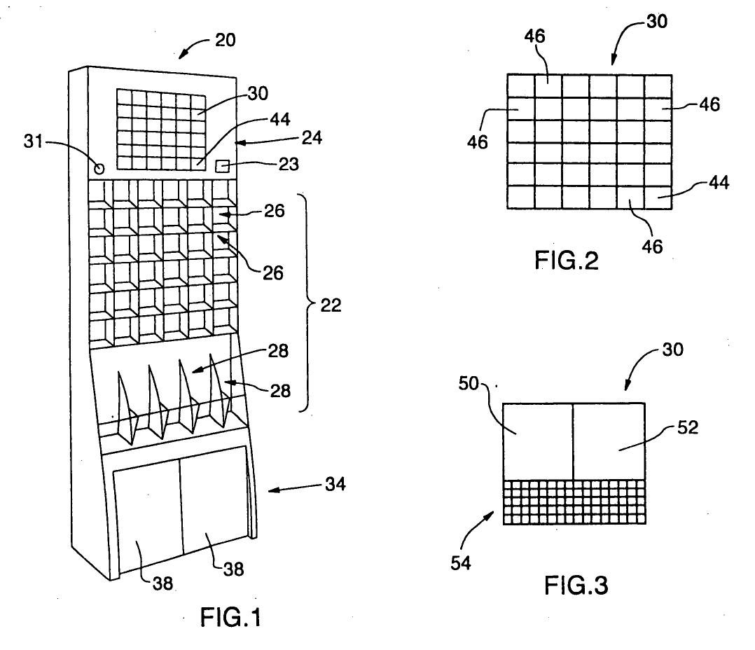

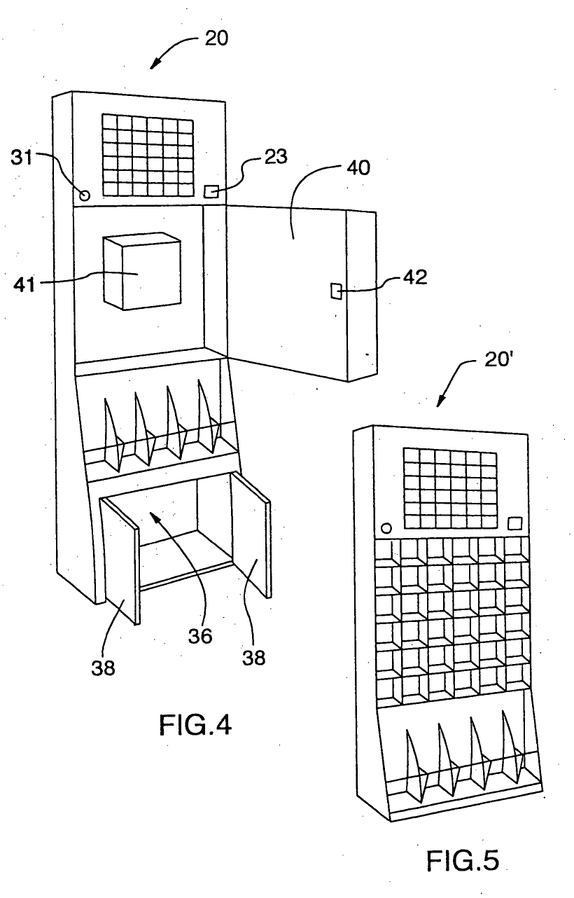

With general reference to FIGS. 1, 4, a first preferred embodiment of the present invention, an advertising display apparatus, is illustrated, and is designated by the general reference numeral 20.

The apparatus 20 comprises a printed material display portion 22 and a presentation portion 24.

The printed material display portion 22 includes a plurality of printed material holders 26,28. The printed material holders 26,28 preferably include a plurality of business card holders 26 and a plurality of brochure holders 28.

The presentation portion 24 includes video means 30 for displaying visual images, audio means 31 for producing sounds and a mouse pad 23. In the preferred embodiment, the video means 30 comprises a touch-sensitive LCD computer monitor and the audio means 31 comprises a speaker.

The apparatus 20 has an operative configuration wherein the presentation portion 24 is positioned such that the visual images can be viewed by passers-by, and wherein the printed material holders 26,28 are positioned such that passers-by can conveniently peruse the information on printed materials, namely, business cards and brochures, contained therein, and draw same from the holders 26,28 as desired.

In the preferred embodiment, the apparatus 20 is a kiosk, with the presentation portion 24 and the printed material display portion 22 constructed integrally with a stand portion 34. The stand portion 34 includes an area 36, accessible by hinged panels 38, wherein supplies of printed materials can be inventoried. A further panel 40, upon which the printed material holders 26,28 are carried, is hinged and securable by locks 42, to provide secure storage of an Internet-linked computer processor 40 that is operably coupled to the monitor 30, speaker 31 and mouse pad 23.

In deployment, the apparatus 20 is positioned in a high-traffic area in a secure location, such as a shopping mall or airport and stocked with business cards, brochures and electronic-format multimedia presentations of advertisers which have made arrangements with the provider of the apparatus.

In a first mode of operation, the processor 40 causes the monitor to assume a first appearance, as shown in FIG. 2, wherein a grid of icons or virtual buttons 46,44 are shown. Buttons 46 are associated with multimedia presentations of advertisers; a passer-by who touches such a button 46 causes the display 30 and speaker 31 to present the multimedia presentation associated therewith; upon completion of the presentation, the monitor 30 reverts to the first appearance shown in FIG. 2. Depression of button 44 causes the processor 40 to assume a second mode of operation.

In the second mode of operation, the processor 40 causes the monitor 30 to adopt a second appearance, shown in FIG. 3, wherein a commercial window 50, an Internet window 52 and a virtual keypad area 54 are displayed. In this mode, the Internet window 52, virtual keypad 54, processor 40 and mouse pad 23 collectively define a functional Internet browser, through which users can access the Internet. While in the second mode, multimedia presentations of the advertisers are presented in looping fashion via the commercial window 50 and speaker 31.

If the processor detects no user input activity by way or the mouse pad 23 or virtual keypad 54 for a relatively protracted predetermined period of time, for example, 2 minutes, the system reverts to the first mode of operation.

From time to time, the provider of the apparatus will attend to restock the holders, so as to ensure that participating advertisers (and only participating advertisers) are properly represented. The multimedia advertising content can be replenished by replacing storage media, for example, a DVD or compact disc, or alternatively, remotely, through the Internet connection.

Whereas FIGS. 1,4 show a kiosk, which forms the first preferred embodiment of the present invention, it should be understood that the invention could equally be adapted for wall mounting, as shown in FIG. 5, which shows an apparatus 20′ adapted for wall-mounting, and thus, lacking a stand portion. In all other respects, the wall-mounted embodiment 20′ is identical to the kiosk model 20, and thus, it is not described herein in detail.

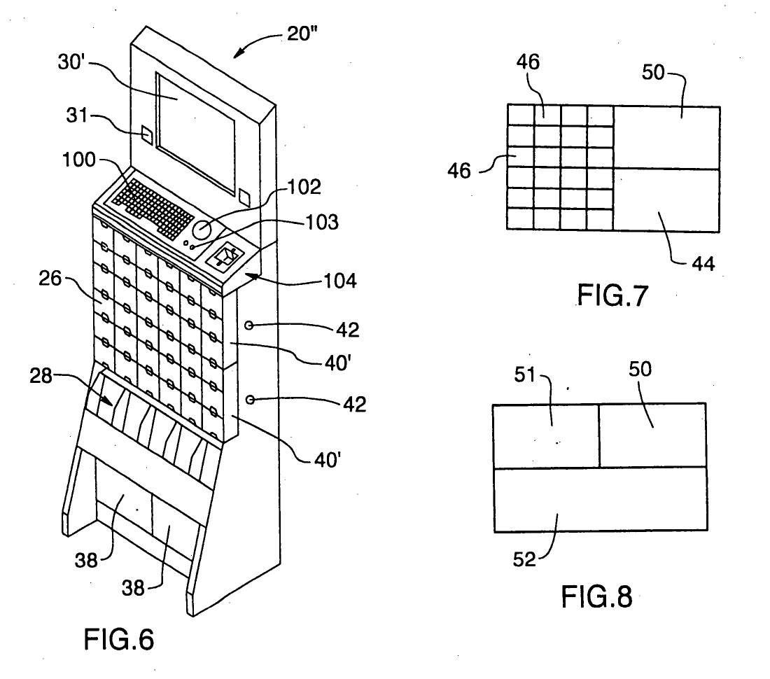

FIG. 6 shows a third preferred embodiment 20″ of the present invention. This embodiment differs from that shown in FIGS. 1,4 in that a keyboard 100 is provided, a track ball 102 is provided in the place of the mouse pad and the screen 30′ provided is not touch-sensitive. The track ball 102 has selection buttons 103. As well, whereas a single panel 40 is shown in FIG. 4, in the embodiment of FIG. 6, the business card holders are provided on two panels 40′. Further, a credit card reader 104 is provided. In other respects, this device is physically similar to that of FIG. 4, and as such, is not described herein in detail.

In a first mode of operation, the processor causes the monitor 30 and speaker 31 to present, in full screen format, multimedia presentations of advertisers. The presentations loop.

If a passerby actuates the keyboard 100, the track ball 102 or a button 103, the processor causes the screen to assume an appearance as shown in FIG. 7, wherein a grid of virtual buttons 46 are shown. An internet panel or button 44 is also shown, as is a commercial window 50, wherein the advertisements continue to loop. Buttons 46 are associated with multimedia presentations of advertisers; a passer-by who selects such a button using the track ball causes the display 30 and speaker 31 to present the multimedia presentation associated therewith, in full screen format; upon completion of the presentation, the monitor 30 reverts to the full screen advertisement loop.

Selection of panel 44 causes the processor 40 to assume a second mode of operation.

In the second mode of operation, the processor causes the monitor 30 to adopt a third appearance, shown in FIG. 8, wherein a commercial window 50, an operator window 51 and an Internet window 52 are displayed. The Internet window 52 prompts the user to insert a credit or other payment card. Following such insertion, the Internet window 52, keyboard, processor and track ball 23 collectively define a functional Internet browser, through which users can access the Internet. While in the second mode, the multimedia presentations continue to loop in the commercial window 50 and speaker 31. The operator window 51 displays advertisement for the operator of the kiosk or the premises in which the kiosk is located.

Yet further changes can be made.

For example, whereas an LCD monitor is shown in the preferred embodiments, other information presentation devices, such as plasma screens or tube-type monitors can be employed.

Further, whereas an Internet-coupled processor is employed in the preferred embodiments to drive the monitor, other arrangements are possible. For example, a DVD player could be substituted for the processor, in which event, the multimedia presentations could be cycled in a continuous loop.

In certain situations, audio may be inappropriate, and can readily be omitted.

Yet further, whereas the panels on the storage area in the first and third preferred embodiments are shown as hinged panels, other arrangements, such as slidable panels could be readily substituted, and indeed, the panels can be avoided altogether, as evidenced by the second preferred embodiment shown in FIG. 5. Additionally, whereas the preferred embodiments include business card holders and brochure holders, either or both can be omitted, if desired.

Yet further, the device can be configured to operate differently. For example, whereas in the embodiment of FIG. 6, the Internet browser only becomes active upon insertion of a payment card, this need not be the case. In some situations, Internet access could be provided free of charge, to drive traffic to the kiosk. For example, this might be a preferred method of operation in situations wherein the operator of the kiosk pays space rent to the operator of the premises in which the kiosk is situated. In other situations, Internet access would only be available for charge. In this case, the operator of the premises in which the kiosk was situated might waive space rent in exchange for a portion or all of the Internet revenues.

Accordingly, the invention should be understood as limited only by the claims appended hereto, purposively construed.

1. An advertising display apparatus comprising:
printed material display portion including a plurality of printed material holders for holding printed materials; and
presentation portion including video means for displaying visual images,
herein, in use, the visual images can be viewed by passers-by and the printed material holders are positioned such that passers-by can conveniently peruse the information on the printed materials held by the holders and draw printed materials therefrom as desired.

2. Apparatus according to claim 1, wherein the printed material holders include a plurality of business card holders.

3. Apparatus according to claim 1, wherein the printed material holders include a plurality of brochure holders.

4. Apparatus according to claim 1, further comprising audio means for producing sound.

5. Apparatus according to claim 1, wherein the video means comprises a touch-sensitive display.

6. Apparatus according to claim 1, wherein the audio means comprises a speaker.

7. Apparatus according to claim 1, configured as a kiosk.

8. Apparatus according to claim 1, configured for wall-mounting.

9. An advertising display apparatus comprising:
a printed material display portion including a plurality of printed material holders for holding printed materials;
a monitor for displaying visual images;
means for receiving user inputs; and
a speaker for producing sounds,
wherein, in use, the visual images can be viewed by passers-by, the sounds can be heard by passers-by, and the printed material holders are positioned such that passers-by can conveniently peruse the information on the printed materials held by the holders and draw printed materials therefrom as desired.

10. Apparatus according to claim 9, wherein the monitor is a touch-sensitive monitor and defines said means for receiving user inputs.

11. Apparatus according to claim 10, adapted to assume a first mode of operation, wherein the monitor assumes a first appearance wherein it presents a plurality of touch-actuable advertisement buttons.

12. Apparatus according to claim 11, wherein actuation of an advertisement button causes a multimedia presentation to be presented via the monitor and the speaker, and whereon, upon completion of the multimedia presentation, the monitor reverts to the first appearance.

13. Apparatus according to claim 12, wherein, in the first appearance, the monitor further displays a touch-actuable Internet button.

14. Apparatus according to claim 13, wherein actuation of the Internet
button causes the monitor to assume a second appearance wherein it displays a commercial window, an Internet window and a virtual keypad.

15. Apparatus according to claim 14, further comprising a mouse pad, wherein the virtual keypad, mouse pad, processor and Internet window define an Internet browser.

16. Apparatus according to claim 15, wherein the monitor reverts from the second appearance to the first appearance when a predetermined period has elapsed during which period no inputs have been received from the mouse pad or the virtual keypad.

17. Apparatus according to claim 16, wherein multimedia advertisements are presented via the speaker and the commercial window while the display is in the second appearance.

18. Apparatus according to claim 9, wherein the means for receiving user inputs comprises a keyboard and a track ball.

19. Apparatus according to claim 18, wherein the apparatus has an idle mode of operation wherein multimedia advertisements are presented in looping fashion through the monitor and speakers, and reverts to a first mode of operation upon receipt of a user input in which mode of operation the monitor assumes a first appearance wherein it presents a plurality of user-selectable buttons.

20. Apparatus according to claim 19, wherein the user-selectable buttons include
advertiser buttons, actuation of a respective one of which advances the loop to present the multimedia advertisement associated with the respective advertisement in full screen, and
an Internet button, actuation of which causes the screen to assume a second appearance wherein it displays:
a commercial window in which the advertisement loop is shown; and
an Internet window,
wherein the keyboard, track ball and Internet window define an Internet browser.
